(19) United States
(12) Patent Application Publication
(10) Pub. No.: US 2024/0195486 A1
(43) Pub. Date: Jun. 13, 2024

(54) METHOD AND APPARATUS FOR RELAY REPLACEMENT

(71) Applicant: Lenovo (Beijing) Limited, Beijing (CN)

(72) Inventors: Lianhai Wu, Beijing (CN); Mingzeng Dai, Shanghai (CN); Yibin Zhuo, Beijing (CN); Haiming Wang, Beijing (CN); Le Yan, Shanghai (CN)

(73) Assignee: Lenovo (Beijing) Limited, Beijing (CN)

(21) Appl. No.: 18/554,526

(22) PCT Filed: Apr. 16, 2021
(86) PCT No.: PCT/CN2021/087926

§ 371 Date: Oct. 9, 2023

(51) Int. Cl. H04B 7/185; H04W 24/04; H04W 36/00; H04W 76/10; H04W 88/04

(52) U.S. Cl. CPC H04B 7/18504; H04W 24/04; H04W 36/0033; H04W 76/10; H04W 88/04

(57) ABSTRACT

Embodiments of the present disclosure relate to methods and apparatuses for relay replacement. According to some embodiments of the disclosure, a method may include: receiving assistant information associated with a first network node, which functions as a relay node between the BS and a user equipment (UE); and in response to initiating a replacement procedure to replace the first network node based on the received assistant information, deactivating the first network node and activating a second network node as the relay node.

### TECHNICAL FIELD

Embodiments of the present disclosure generally relate to wireless communication technology, especially to vehicle or drone-mounted relay replacement in a wireless communication system.

### BACKGROUND

In a wireless communication system, a base station (BS) may be distributed over a geographic region and may serve a number of user equipment (UE) within a serving area, for example, a cell or a cell sector, via wireless communication links.

Installing additional base stations in certain environments may face typical deployment challenges and burdens. In some urban environments, one can expect the presence and availability of many vehicles, for example, buses, taxis, goods, food and delivery vehicles, etc., typically moving at low or pedestrian speed (or temporarily stationary). Some of such vehicles can follow a certain known or predictable itinerary or be situated in specific locations, for example, outside stadiums, and through or around areas where coverage and capacity need to be improved. The 3rd generation partnership project (3GPP) is interested in introducing these vehicles into the wireless network to improve and extend the coverage of a BS.

Moreover, in recent years, aerial vehicles, such as unmanned aerial vehicles (UAVs) (also known as “drones”) are becoming ever more popular. For example, more and more UAVs are commercially used in package delivery, search-and-rescue, monitoring of critical infrastructure, wildlife conservation, and as flying cameras and in surveillance. 3GPP has observed this trend and is interested in introducing UAVs or drones into the wireless network.

Therefore, the industry desires a technology to introduce vehicles or UAVs into the wireless network.

### SUMMARY

Some embodiments of the present disclosure provide a method performed by a base station (BS). According to some embodiments of the present disclosure, the method may include: receiving assistant information associated with a first network node, which functions as a relay node between the BS and a user equipment (UE); and in response to initiating a replacement procedure to replace the first network node based on the received assistant information, deactivating the first network node and activating a second network node as the relay node.

Some embodiments of the present disclosure provide a method performed by a network node. According to some embodiments of the present disclosure, the method may include: transmitting, to a base station (BS), assistant information associated with the network node, wherein the network node functions as a relay node between the BS and a user equipment (UE); receiving, from the BS, a deactivation indication to deactivate the network node as the relay node; and deactivating the network node in response to receiving the deactivation indication.

In some embodiments of the present disclosure, the network node may be a drone or a vehicle. In some embodiments of the present disclosure, the assistant information may include one or more of: a request for deactivating a function of a relay between the BS and the UE at the network node; a remaining power of the network node; the number of UEs served by the network node; a remaining serving time of the network node; and an acknowledgement that all UEs served by the network node have been handed over or that no more UE is being served by the network node.

In some embodiments of the present disclosure, the deactivation indication may indicate one or more of: an ID of another network node, which may be different from that of the network node; a condition for deactivating a function of a relay between the BS and the UE at the network node; and time information to deactivate a function of a relay between the BS and the UE at the network node.

In some embodiments of the present disclosure, the condition may indicate one or more of: time information for handing over a predetermined number of UEs served by the network node to one or more other network nodes; a plurality of UEs to be handed over by the network node to one or more other network nodes; and a remaining power of the network node.

In some embodiments of the present disclosure, the deactivating the network node may include: performing a handover procedure to hand over at least one UE served by the network node to a new cell according to the condition; and deactivating the function of a relay between the BS and the UE in response to the condition being met.

In some embodiments of the present disclosure, the deactivating the network node may include: performing a handover procedure to hand over at least one UE served by the network node to a new cell in response to receiving the deactivation indication. In some embodiments of the present disclosure, the deactivating the network node may include: deactivating a function of a relay between the BS and the UE in response to receiving the deactivation indication.

In some embodiments of the present disclosure, the time information may indicate an absolute time value or a value of a timer.

In some embodiments of the present disclosure, the deactivating the network node may include: deactivating the function of a relay between the BS and the UE according to the time information.

In some embodiments of the present disclosure, the method may further include receiving, from an idle UE, a radio resource control (RRC) setup request message after receiving the deactivation indication; and transmitting, to the idle UE, an RRC reject message in response to the RRC setup request message, wherein the RRC reject message may include at least one of: a target cell ID; and a cause value of cell replacement.

In some embodiments of the present disclosure, the method may further include transmitting a radio resource control (RRC) release message to the UE served by the network node after receiving the deactivation indication, wherein the RRC release message may include a target cell ID.

In some embodiments of the present disclosure, the method may further include receiving, from an inactive UE, a radio resource control (RRC) resume request message after receiving the deactivation indication; and transmitting, to the inactive UE, an RRC release message, wherein the RRC release message may include a target cell ID.

Some embodiments of the present disclosure provide a method performed by a network node. According to some embodiments of the present disclosure, the method may include: receiving, from a base station (BS), an activation indication to activate the network node as a relay node between the BS and a user equipment (UE); and activating the network node as the relay node in response to receiving the activation indication. In some embodiments of the present disclosure, the network node may be a drone or a vehicle.

The activating the network node as the relay node may include broadcasting system information using an ID of the network node. The activation indication may indicate an ID of the network node. The method may further include receiving, from the BS, UE context of a UE served by another network node.

The activation indication may indicate a condition for activating the network node as the relay node, which includes one or more of: time information to activate the network node as the relay node; and a position of the network node to activate the network node as the relay node. The time information may indicate an absolute time value or a value of a timer. The activating the network node as the relay node may include activating a function of a relay at the network node in response to the condition being met.

Some embodiments of the present disclosure provide a base station (BS). The BS may include a transceiver and a processor coupled to the transceiver. The transceiver may be configured to receive assistant information associated with a first network node, wherein the first network node functions as a relay node between the BS and a user equipment (UE). The processor may be configured to deactivate the first network node and activate a second network node as a relay node in response to initiating a replacement procedure to replace the first network node based on the received assistant information. In some embodiments of the present disclosure, each of the first network node and the second network node may be a drone or a vehicle.

The assistant information may include one or more of: a request for deactivating a function as a relay between the BS and the UE at the first network node; a remaining power of the first network node; the number of UEs served by the first network node; a remaining serving time of the first network node; and an acknowledgement that all UEs served by the first network node have been handed over or that no more UE is being served by the first network node.

To deactivate the first network node, the processor may be configured to cause the transceiver to transmit a first indication to the first network node, and wherein the first indication may indicate one or more of: an ID of the second network node, which may be different from that of the first network node; a condition for deactivating a function as a relay between the BS and the UE at the first network node; and time information to deactivate a function as a relay between the BS and the UE at the first network node.

To activate the second network node, the processor may be configured to cause the transceiver to transmit a second indication to the second network node, and wherein the second indication may indicate an ID of the second network node.

The condition may indicate one or more of: time information for handing over a predetermined number of UEs served by the first network node to the second or another network node; a plurality of UEs to be handed over by the first network node to the second or another network node; and a remaining power of the first network node.

In the case that a first UE being served by the first network node may be handed over to another network node that may be different from the second network node, the transceiver may be further configured to transmit UE context of the first UE to the second network node.

In some embodiments of the present disclosure, an ID of the second network node may be the same as that of the first network node.

To activate the second network node, the processor may be configured to cause the transceiver to transmit a second indication to the second network node, and wherein the second indication may indicate one or more of: time information to activate a function of a relay at the second network node; and a position of the second network node to activate a function of a relay at the second network node.

The time information may indicate an absolute time value or a value of a timer.

The transceiver may be further configured to: transmit UE context of at least one UE served by the first network node to the second network node.

The transceiver may be further configured to: receive, from an idle UE via the first network node, a radio resource control (RRC) setup request message in response to initiating the replacement procedure to replace the first network node; and transmit, to the idle UE via the first network node, an RRC reject message in response to receiving the RRC setup request message, wherein the RRC reject message may include at least one of: an ID of the second network node; and a cause value of cell replacement.

The transceiver may be further configured to: in response to initiating the replacement procedure to replace the first network node, transmit a radio resource control (RRC) release message to the UE connected to the BS via the first network node, wherein the RRC release message may include an ID of the second network node.

The transceiver may be further configured to: receive, from an inactive UE via the first network node, a radio resource control (RRC) resume request message after initiating the replacement procedure to replace the first network node; and transmit, to the inactive UE via the first network node, an RRC release message, wherein the RRC release message may include an ID of the second network node.

Some embodiments of the present disclosure provide a network node. The network node may include a processor and a transceiver coupled to the processor. The transceiver may be configured to: transmit, to a base station (BS), assistant information associated with the network node, wherein the network node functions as a relay node between the BS and a user equipment (UE); and receive, from the BS, a deactivation indication to deactivate the network node as the relay node. The processor may be configured to deactivate the network node in response to receiving the deactivation indication. In some embodiments of the present disclosure, the network node may be a drone or a vehicle.

The assistant information may include one or more of: a request for deactivating a function of a relay between the BS and the UE at the network node; a remaining power of the network node; the number of UEs served by the network node; a remaining serving time of the network node; and an acknowledgement that all UEs served by the network node have been handed over or that no more UE is being served by the network node.

The deactivation indication may indicate one or more of: an ID of another network node, which may be different from that of the network node; a condition for deactivating a function of a relay between the BS and the UE at the network node; and time information to deactivate a function of a relay between the BS and the UE at the network node.

The condition may indicate one or more of: time information for handing over a predetermined number of UEs served by the network node to one or more other network nodes; a plurality of UEs to be handed over by the network node to one or more other network nodes; and a remaining power of the network node.

To deactivate the network node, the processor may be configured to: perform a handover procedure to hand over at least one UE served by the network node to a new cell according to the condition; and deactivate the function of a relay between the BS and the UE in response to the condition being met.

To deactivate the network node, the processor may be configured to: perform a handover procedure to hand over at least one UE served by the network node to a new cell in response to receiving the deactivation indication.

To deactivate the network node, the processor may be configured to: deactivate a function of a relay between the BS and the UE in response to receiving the deactivation indication.

The time information may indicate an absolute time value or a value of a timer.

To deactivate the network node, the processor may be configured to: deactivate the function of a relay between the BS and the UE according to the time information.

The transceiver may be further configured to: receive, from an idle UE, a radio resource control (RRC) setup request message after receiving the deactivation indication; and transmit, to the idle UE, an RRC reject message in response to the RRC setup request message, wherein the RRC reject message may include at least one of: a target cell ID; and a cause value of cell replacement.

The transceiver may be further configured to: transmit a radio resource control (RRC) release message to the UE served by the network node after receiving the deactivation indication, wherein the RRC release message may include a target cell ID.

The transceiver may be further configured to: receive, from an inactive UE, a radio resource control (RRC) resume request message after receiving the deactivation indication; and transmit, to the inactive UE, an RRC release message, wherein the RRC release message may include a target cell ID.

Some embodiments of the present disclosure provide a network node. The network node may include a transceiver and a processor coupled to the transceiver. The transceiver may be configured to receive, from a base station (BS), an activation indication to activate the network node as a relay node. The processor may be configured to activate the network node as the relay node in response to receiving the activation indication. In some embodiments of the present disclosure, the network node may be a drone or a vehicle.

To activate the network node as the relay node, the processor may be configured to cause the transceiver to broadcast system information using an ID of the network node. The activation indication may indicate an ID of the network node.

The transceiver may be further configured to receive, from the BS, UE context of a UE served by another network node.

The activation indication may indicate a condition for activating the network node as the relay node, which includes one or more of: time information to activate the network node as the relay node; and a position of the network node to activate the network node as the relay node.

The time information may indicate an absolute time value or a value of a timer.

To activate the network node as the relay node, the processor may be configured to activate a function of a relay at the network node in response to the condition being met.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Embodiments of the present disclosure provide technical solutions to facilitate the usage of a vehicle or drone as a relay and can facilitate and improve the implementation of various communication technologies, such as 5G NR.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present disclosure;

FIG. 2 illustrates an exemplary procedure for wireless communications in accordance with some embodiments of the present disclosure;

FIG. 3 illustrates an exemplary procedure for wireless communications in accordance with some embodiments of the present disclosure;

FIG. 4 illustrates an exemplary procedure for wireless communications in accordance with some embodiments of the present disclosure;

FIG. 5 illustrates an exemplary procedure for wireless communications in accordance with some embodiments of the present disclosure; and

FIG. 6 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

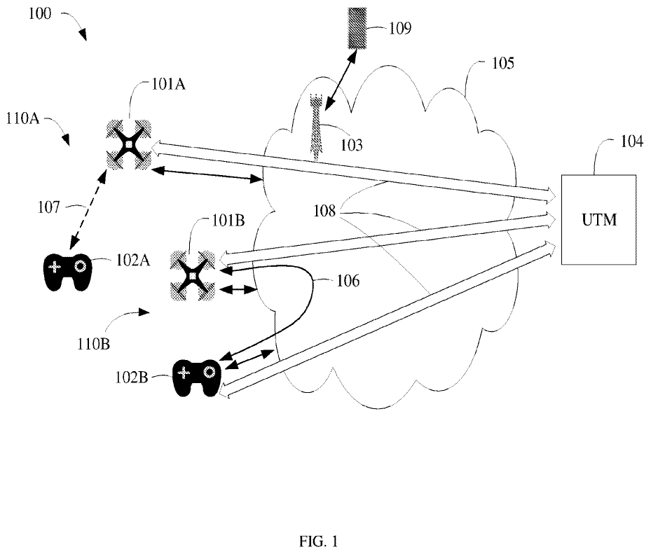

FIG. 1 illustrates a schematic diagram of a wireless communication system 100 in accordance with some embodiments of the present disclosure.

The wireless communication system 100 may include a wireless network (e.g., a 3GPP mobile network) 105. At least one BS may be deployed within wireless network 105 and may provide services to one or more UEs. For example, UE 109 may access BS 103. UE 109 and BS 103 may support communication based on, for example, 3G. Long-Term Evolution (LTE), LTE-Advanced (LTE-A), New Radio (NR), or other suitable protocol(s). For example, BS 103 may include an eNB or a gNB. UE 109 may include, for example, but is not limited to, a computing device, a wearable device, a mobile device, an IoT device, etc. In some embodiments of the present disclosure, UE 109 may be V2X UEs, for example, vehicles. Persons skilled in the art should understand that as technology develops and advances, the terminologies described in the present disclosure may change, but should not affect or limit the principles and spirit of the present disclosure.

The wireless communication system 100 may include an unmanned aerial system (UAS) (e.g., UAS 110A and UAS 110B), which may include an unmanned aerial vehicle (UAV) and a UAV controller. A UAV may be an aircraft without a human pilot onboard; or otherwise in some cases a UAV can be controlled by a UAV controller and may have a range of autonomous flight capabilities. A UAV can be controlled by different UAV controllers; however, at any given time, a UAV is under the control of only one UAV controller. There are various mechanisms to ensure which UAV controller is active and controlling a specific UAV.

For example, in FIG. 1, UAS 110A may include UAV 101A and UAV controller 102A, and UAS 110B may include UAV 101B and UAV controller 102B. UAV 101A can be controlled by UAV controller 102A and UAV 101B can be controlled by UAV controller 102B.

A UAV (e.g., UAV 101A or UAV 101B) or UAV controller (e.g., UAV controller 102A or UAV controller 102B) may exchange application data traffic 108 with unmanned aerial system traffic management (UTM) (e.g., UTM 104). UTM 104 may be used to provide a number of services to support a UAS and their operations including, for example, UAS identification and tracking, authorization, enforcement, regulation of UAS operations, and also to store the data required for a UAS(s) to operate. UTM 104 may allow authorized users (e.g., air traffic control, public safety agencies) to query the identity and metadata of a UAV (e.g., UAV 101A) and its UAV controller (e.g., UAV controller 102A).

The communication between the UAV and UAV controller may be via a command and control (C2) link, which is the user plane link to convey messages with information of command and control of a UAV operation between a UAV controller and a UAV. The communication requirements for a UAS may cover both the C2 communications and uplink and downlink data to/from the UAS components towards both the serving 3GPP network and network servers.

In some embodiments of the present disclosure, a UxNB (not shown in FIG. 1) may be carried in the air by a UAV (e.g., UAV 101A or UAV 101B) to extend the coverage or increase the capacity of a wireless network (e.g., wireless network 105). The UxNB can provide connectivity to UEs.

In some embodiments of the present disclosure, when using a 3GPP network as the transport network for supporting UAS services, the following C2 communications may be considered to provide UAS services by guaranteeing quality of service (QOS) for the C2 communication.
Direct C2 communication: the UAV controller and UAV may establish a direct C2 link to communicate with each other. In some cases, both the UAV controller and UAV may be registered with the 3GPP network (e.g., 5G network) using the radio resource configured and scheduled provided by the 3GPP network for direct C2 communication.
Network-Assisted C2 communication: the UAV controller and UAV may register and establish respective unicast C2 communication links with the 3GPP network (e.g., 5G network) and communicate with each other via the 3GPP network. Also, both the UAV controller and UAV may be registered with the 3GPP network via different radio access network (RAN) (e.g., next generation RAN (NG-RAN)) nodes. The 3GPP network may need to support mechanisms to handle the reliable routing of C2 communication.
UTM-Navigated C2 communication: the UAV may have been provided a pre-scheduled flight plan, for example, an array of 4D polygons, for autonomous flying. However, the UTM may still maintain a C2 communication link with the UAV in order to regularly monitor the flight status of the UAV, verify the flight status with up-to-date dynamic restrictions, provide route updates, and navigate the UAV whenever necessary.

In FIG. 1, UAV 101A and UAV 101B may be connected to wireless network 105, and may be connected over 3GPP connectivity. UAV controller 102A may not be connected to wireless network 105, and may control UAV 101A via a C2 interface 107 not in 3GPP scope. UAV controller 102B may be connected to wireless network 105, and may control UAV 101B via a C2 interface 106 over 3GPP connectivity. In some embodiments of the present disclosure, UAV controller 102B can control one or more UAV(s).

Although a specific number of UEs, BSs, UASs, UAVs, and UAV controllers are depicted in FIG. 1, it is contemplated that any number of UEs, BSs, UASs, UAVs, and UAV controllers may be included in the wireless communication system 100. Although one UAV and one UAV controller are depicted in a single UAS in FIG. 1, it is contemplated that any number of UAVs and UAV controllers may be included in a single UAS, and a UAV controller may control one or more UAV(s).

As mentioned above, installing additional base stations in certain environments may face typical deployment challenges and burdens. Vehicles and drones may offer a convenient and efficient place in which to install on-board base stations acting as relays to provide wireless network (e.g., 5G) coverage and connectivity to neighboring UEs outside the vehicles or drones. Moreover, vehicle or drone relays are also very suitable and optimal for connecting users or devices (e.g., UEs) inside the vehicles or drones, not only in urban areas, but also other environments, for example, for passengers in buses, cars, taxis, or trains. In other scenarios, for example, during an outdoor sport or pedestrian event, vehicles or drones equipped with relays can conveniently move along with users or devices that are outside the vehicles or drones and provide service to them.

In some examples, the vehicle or drone relays may be a layer 2 (L2) relay, which may include a distributed unit (DU) part similar to that in an integrated access and backhaul (IAB) node. An L2 relay may include a backhaul adaptation protocol (BAP) layer, a radio link control (RLC) layer, a medium access control (MAC) layer, and a physical (PHY) layer. In some examples, the vehicle or drone relays may be a layer 3 (L3) relay, which may include a centralized unit (CU) and a DU. For instance, the DU may include a radio link control (RLC) layer, a medium access control (MAC) layer, and a physical (PHY) layer. The CU may include a radio resource control (RRC) layer, a service data adaptation protocol (SDAP) layer, and a packet data convergence protocol (PDCP) layer.

In the above scenarios and the like, vehicle or drone relays can use wireless backhaul links toward the donor base stations connected to the core network. For example, referring to FIG. 1, in some embodiments of the present disclosure, UAV 101A may act as a drone-based relay and may use BS 103 to connect to the core network.

Embodiments of the present disclosure provide solutions to facilitate the usage of the vehicle or drone as a relay. For instance, a drone-based relay or vehicle-based relay may have limited power, and when, for example, the power of the serving relay is not sufficient to provide the relay service or the serving relay is experiencing a malfunction, the serving relay (hereinafter, “old relay”) may be replaced by a new relay. Solutions for replacing an old relay with a new relay are proposed.

For example, in some embodiments of the present disclosure, the old relay and the new relay may have different cell IDs (e.g., physical cell IDs (PCIs)). The old relay and the new relay may both provide relay service and broadcast system information during a certain time. In some examples, the old relay and the new relay may use the same frequency and/or cover similar coverage, which may cause interference, thereby resulting in, for example, a handover failure at some UEs.

In some embodiments of the present disclosure, the old relay and the new relay may have the same cell ID (e.g., PCI). In response to deactivating or stopping the old relay, the new relay may be activated and start broadcasting system information immediately. However, a time gap may be introduced between the deactivation of the old relay and the activation of the new relay, which could cause, for example, a radio link failure (RLF) at some UEs.

Embodiments of the present disclosure provide enhanced replacement procedures to solve the above issues.

In addition, during the replacement of the old relay, solutions for handling a connection request(s) for the old relay are also proposed.

More details on the embodiments of the present disclosure will be illustrated in the following text in combination with the appended drawings. Although the above issues and the below solutions are described with respect to a specific network architecture or application scenario (e.g., vehicle or drone-based relay), it should be appreciated by persons skilled in the art that the above issues may exist in other specific network architectures or application scenarios (e.g., stationary relay), and the solutions can still solve the above issues.

In the context of the subject disclosure, the expressions “stop a relay service,” “stop a function as a relay,” “deactivate a relay service,” and “deactivate a function as a relay” may be used interchangeably. Similarly, the expressions “start a relay service,” “start a function as a relay,” “activate a relay service,” and “activate a function as a relay” may be used interchangeably.

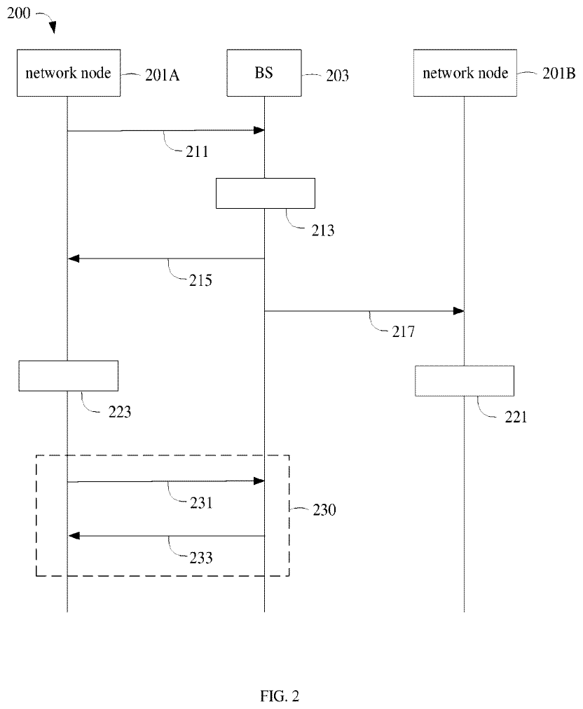

FIG. 2 illustrates an exemplary procedure 200 for wireless communications in accordance with some embodiments of the present disclosure. Details described in all of the foregoing embodiments of the present disclosure are applicable for the embodiments shown in FIG. 2.

Referring to FIG. 2, network node 201A may be connected to BS 203 and may function as a relay node between BS 203 and a UE(s). For example, network node 201A may broadcast system information using its ID (e.g., PCI) within its coverage area so as to provide the relay service. Network node 201A may be a drone or a vehicle. For example, network node 201A may function as UAV 101A or UAV 101B shown in FIG. 1 and BS 203 may function as BS 103 shown in FIG. 1. In the exemplary procedure 200, network node 201A may be an L3 relay.

In operation 211, network node 201A may transmit assistant information associated with network node 201A to BS 203. In some embodiments of the present disclosure, the assistant information may include one or more of: a request for stopping the relay service at network node 201A, the remaining power of network node 201A, the number of UEs served by network node 201A, and a remaining serving time of network node 201A.

In some examples, the transmission may be based on one or more conditions including, for example, the remaining power of network node 201A is less than a threshold. For instance, when network node 201A determines that its power level is less than a configured or predefined threshold, network node 201A may transmit the assistant information to BS 203.

In operation 213, based on the received assistant information, BS 203 may initiate a replacement procedure to replace network node 201A. For example, BS 203 may determine whether to replace network node 201A with a new network node (e.g., network node 201B in FIG. 2) based on the received assistant information. For example, when the power level of the network node 201A is less than a threshold, BS 203 may determine to replace network node 201A with a new network node.

In some other embodiments, a network entity (e.g., operation administration maintenance (OAM) or a UAV platform (e.g., UTM)), which is not shown in FIG. 2, may determine whether to initiate the replacement. For example, BS 203 may transmit the assistant information from network node 201A to the network entity, which may determine whether to replace network node 201A with a new network node based on the received assistant information. The network entity may then inform BS 203 of the determination. For example, the network entity may transmit an indication of replacing network node 201A to BS 203.

In response to initiating the replacement procedure to replace network node 201A. BS 203 may perform a replacement procedure by, for example, deactivating network node 201A and activating network node 201B as a relay node. For example, in operation 215, BS 203 may transmit an indication (indication #1-1) to network node 201A to deactivate network node 201A. In operation 223, in response to receiving indication #1-1, network node 201A may perform a handover procedure to hand over at least one UE (e.g., all UEs) served by network node 201A to a new cell (e.g., a neighbor cell or network node 201B).

In some embodiments of the present disclosure, procedure 230 may be performed (denoted by the dotted block as an option). For example, in response to handing over all UEs served by network node 201A, in operation 231, network node 201A may report, to BS 230, that all UEs served by network node 201A have been handed over. Or network node 201A may report that no UE is being served by network node 201A. In operation 233, BS 230 may transmit an indication to network node 201A to stop the relay service at network node 201A. Network node 201A may stop the relay service in response to receiving the indication.

In some other embodiments of the present disclosure, the assistant information associated with network node 201A may indicate an acknowledgement that all UEs served by network node 201A have been handed over or that no more UE is being served by network node 201A. For example, network node 201A may perform the handover procedure before the transmission of the assistant information, and may stop functioning as a relay node in response to the deactivation.

In some embodiments of the present disclosure, indication #1-1 may indicate one or more of the following: an ID of the new network node (e.g., network node 201B), and a condition for stopping the relay service at network node 201A. The condition may indicate one or more of: time information for handing over a predetermined number of UEs (e.g., all UEs) served by network node 201A to network node 201B or another network node (not shown in FIG. 2); a plurality of UEs to be handed over by network node 201A, for example, to network node 201B or another network node (not shown in FIG. 2); and a remaining power of network node 201A. In the case that the condition is configured to network node 201A, procedure 230 may not be performed. As will be described in detail below, network node 201A may stop the relay service in response to the condition being met.

For example, the time information may indicate a time value (e.g., 5 minutes) for, for example, handing over the predetermined number of UEs) served by network node 201A. In some cases, network node 201A may try to hand over all UEs served by network node 201A within the indicated 5 minutes after receiving indication #1-1, and may stop the relay service in response to the condition being met, for example, 5 minutes later after the reception of indication #1-1.

In some examples, the condition may indicate a plurality of UEs to be handed over by network node 201A. In some cases, BS 203 may indicate a QoS requirement, and network node 201A may try to hand over a UE(s) with a QoS requirement(s) higher than the indicated QoS requirement to a new cell(s). In some cases, BS 203 may indicate the number of UEs, and network node 201A may try to hand over UEs to ensure that the number of UE served by network node 201A is less than the indicated number. Network node 201A may stop the relay service in response to its power level reaching the power level threshold. Network node 201A may stop the relay service in response to the condition being met, for example, when UEs with QoS requirements higher than the indicated QoS requirement are handed over to new cells, or the number of UE served by network node 201A is less than the indicated number.

In some examples, the condition may indicate a power level threshold (e.g., 5% of the full power). Network node 201A may try to hand over all UEs served by network node 201A before its power level reaches the power level threshold and may stop the relay service in response to the condition being met, for example, when its power level reaches the power level threshold.

In operation 217, BS 203 may transmit an indication (indication #1-2) to network node 201B, which is connected to the BS 203, to activate network node 201B as a relay node. Network node 201B may be a drone or a vehicle.

In operation 221, in response to receiving indication #1-2, network node 201B may start the relay service. For example, network node 201B may broadcast system information using its ID (e.g., PCI), which may be different from that of network node 201A. In some embodiments of the present disclosure, the ID (e.g., PCI) of network node 201B may be included in indication #1-2.

It should be appreciated by persons skilled in the art that the sequence of the operations in exemplary procedure 200 may be changed and some of the operations in exemplary procedure 200 may be eliminated or modified, without departing from the spirit and scope of the disclosure. For example, although in FIG. 2, operation 215 is shown before operation 217, in some other embodiments of the present disclosure, operation 217 may be performed prior to operation 215.

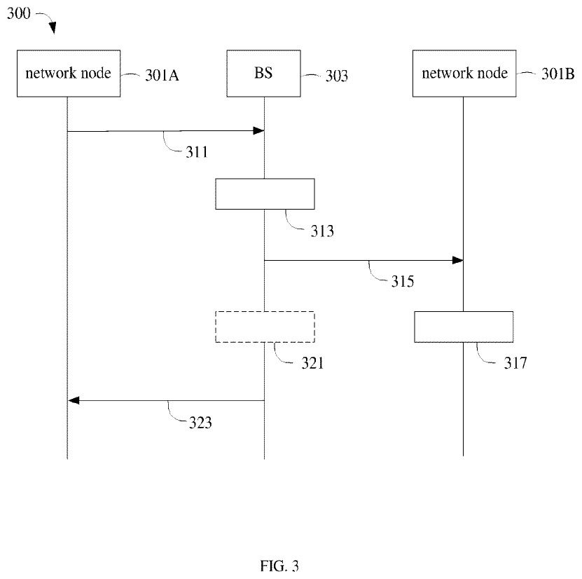

FIG. 3 illustrates an exemplary procedure 300 for wireless communications in accordance with some embodiments of the present disclosure. Details described in all of the foregoing embodiments of the present disclosure are applicable for the embodiments shown in FIG. 3.

Referring to FIG. 3, network node 301A may be connected to BS 303 and may function as a relay node between BS 303 and a UE(s). For example, network node 301A may broadcast system information using its ID (e.g., PCI) within its coverage area so as to provide the relay service. Network node 301A may be a drone or a vehicle. For example, network node 301A may function as UAV 101A or UAV 101B shown in FIG. 1 and BS 303 may function as BS 103 shown in FIG. 1. In the exemplary procedure 300, network node 301A may be an L2 relay.

In operation 311, network node 301A may transmit assistant information associated with network node 301A to BS 303. In some embodiments of the present disclosure, the assistant information may include one or more of: a request for stopping the relay service at network node 301A, the remaining power of network node 301A, the number of UEs served by network node 301A, a remaining serving time of network node 301A, and an acknowledgement that all UEs served by network node 301A have been handed over or that no more UE is being served by network node 301A.

In some examples, the transmission may be based on one or more conditions including, for example, the remaining power of network node 301A is less than a threshold. For instance, when network node 301A determines that its power level is less than a configured or predefined threshold, network node 301A may transmit the assistant information to BS 303.

In operation 313, based on the received assistant information, BS 303 may initiate a replacement procedure to replace network node 301A. For example, BS 303 may determine whether to replace network node 301A with a new network node (e.g., network node 301B in FIG. 3) based on the received assistant information. For example, when the power level of the network node 301A is less than a threshold, BS 303 may determine to replace network node 301A with a new network node. An F1 (e.g., between CU of BS 303 and DU of the new network node) interface may have been established between the new network node and BS 303.

In some other embodiments, a network entity (e.g., an OAM or a UAV platform (e.g., UTM)), which is not shown in FIG. 3, may determine whether to initiate the replacement. For example, BS 303 may transmit the assistant information from network node 301A to the network entity, which may determine whether to replace network node 301A with a new network node based on the received assistant information. The network entity may then inform BS 303 of the determination. For example, the network entity may transmit an indication of replacing network node 301A to BS 303.

In response to initiating the replacement procedure to replace network node 301A, BS 303 may perform a replacement procedure by, for example, deactivating network node 301A and activating network node 301B as a relay node. For example, in operation 315, BS 303 may transmit an indication (indication #2-2) to network node 301B, which has established an F1 interface with BS 303, to activate network node 301B as a relay node. Network node 301B may be a drone or a vehicle.

In operation 317, in response to receiving indication #2-2, network node 301B may start the relay service. For example, network node 301B may broadcast system information using its ID (e.g., PCI), which may be different from that of network node 301A. In some embodiments of the present disclosure, the ID (e.g., PCI) of network node 301B may be included in indication #2-2.

In response to initiating the replacement procedure, in operation 321 (denoted by the dotted block as an option), BS 303 may perform a handover procedure to hand over at least one UE (e.g., all UEs) served by network node 301A to a new cell (e.g., a neighbor cell, network node 301B, or another network node). In some examples, a conditional handover (CHO), a dual active protocol stack (DAPS) handover, or both may be employed.

In some embodiments of the present disclosure, BS 303 may hand over a UE served by network node 301A to a cell or a network node different from network node 301B. BS 303 may transmit UE context data of this UE to network node 301B, which can ensure a successful re-establishment of the UE.

In response to initiating the replacement procedure (e.g., in response to handing over all UEs served by network node 301A), BS 303 may, in operation 323, transmit an indication (indication #2-1) to network node 301A to deactivate network node 301A. Network node 301A may stop the relay service in response to receiving indication #2-1.

It should be appreciated by persons skilled in the art that the sequence of the operations in exemplary procedure 300 may be changed and some of the operations in exemplary procedure 300 may be eliminated or modified, without departing from the spirit and scope of the disclosure. For example, although in FIG. 3, operation 315 is shown before operation 323, in some other embodiments of the present disclosure, operation 323 may be performed prior to operation 315.

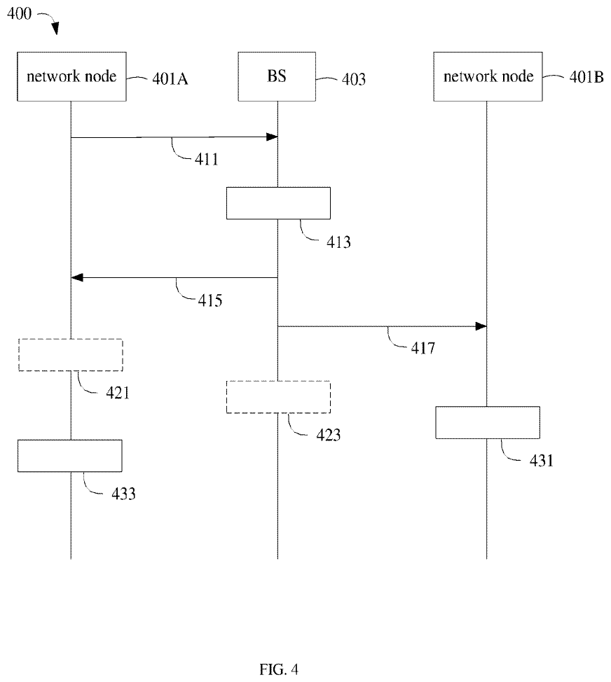

FIG. 4 illustrates an exemplary procedure 400 for wireless communications in accordance with some embodiments of the present disclosure. Details described in all of the foregoing embodiments of the present disclosure are applicable for the embodiments shown in FIG. 4.

Referring to FIG. 4, network node 401A may be connected to BS 403 and may function as a relay node between BS 403 and a UE(s). For example, network node 401A may broadcast system information using its ID (e.g., PCI) within its coverage area so as to provide the relay service. Network node 401A may be a drone or a vehicle. For example, network node 401A may function as UAV 101A or UAV 101B shown in FIG. 1 and BS 403 may function as BS 103 shown in FIG. 1. In the exemplary procedure 400, network node 401A may be an L2 relay or an L3 relay.

In operation 411, network node 401A may transmit assistant information associated with network node 401A to BS 403. In some embodiments of the present disclosure, the assistant information may include one or more of: a request for stopping the relay service at network node 401A, the remaining power of network node 401A, the number of UEs served by network node 401A, and a remaining serving time of network node 401A, and an acknowledgement that all UEs served by network node 401A have been handed over or that no more UE is being served by network node 401A.

In some examples, similar to the descriptions with respect to FIGS. 2 and 3, the transmission may be based on one or more conditions including, for example, the remaining power of network node 401A is less than a threshold.

In operation 413, based on the received assistant information, BS 403 may initiate a replacement procedure to replace network node 401A. For example, BS 403 may determine whether to replace network node 401A with a new network node (e.g., network node 401B in FIG. 4) based on the received assistant information. For example, when the power level of the network node 401A is less than a threshold, BS 403 may determine to replace network node 401A with a new network node.

In some other embodiments, similar to the descriptions with respect to FIGS. 2 and 3, a network entity (e.g., OAM or a UAV platform (e.g., UTM)), which is not shown in FIG. 4, may determine whether to initiate the replacement.

In some embodiments of the present disclosure, network node 401A and its replacement node (e.g., network node 401B) may use the same ID (e.g., PCI).

In response to initiating the replacement procedure to replace network node 401A, BS 403 may perform a replacement procedure by, for example, deactivating network node 401A and activating network node 401B as a relay node. For example, BS 403 may, in operation 415, transmit an indication (indication #3-1) to network node 401A to deactivate network node 401A. BS 403 may transmit, in operation 417, an indication (indication #3-2) to network node 401B, which is connected to the BS 403, to activate network node 401B as a relay node. Network node 401B may be a drone or a vehicle. In some embodiments of the present disclosure, the ID (e.g., PCI) of network node 401B may be included in indication #3-2.

In some embodiments of the present disclosure, indication #3-1 may indicate time information to stop the relay service at network node 401A. The time information may indicate an absolute time value or a value of a timer. In some examples, when the absolute time value is reached, network node 401A may stop the relay service. In some examples, network node 401A may start a timer according to the value of the timer in response to receiving indication #3-1, and may stop the relay service in response to the expiry of the timer.

In some embodiments of the present disclosure, indication #3-2 may indicate one or more of: time information to start the relay service at network node 401B, and a position of network node 401B to start the relay service. In some examples, similar to indication #3-1, the time information indicated by indication #3-2 may indicate an absolute time value or a value of a timer. In some examples, when network node 401B enters the indicated position, network node 401B may start the relay service.

In some embodiments of the present disclosure, network node 401A may be an L3 relay. In response to receiving indication #3-1, in operation 421 (denoted by the dotted block as an option), network node 401A may perform a handover procedure to hand over at least one UE (e.g., all UEs) served by network node 401A to a new cell (e.g., a neighbor cell when the replacement node has not started working as a relay node).

In some embodiments of the present disclosure, network node 401A may be an L2 relay. In response to initiating the replacement procedure, in operation 423 (denoted by the dotted block as an option), BS 403 may perform a handover procedure to hand over at least one UE (e.g., all UEs) served by network node 401A to a new cell (e.g., a neighbor cell when the replacement node has not started working as a relay node).

In some embodiments of the present disclosure, BS 403 may transmit UE context data of at least one UE (e.g., all UEs) served by network node 401A to the replacement node (e.g., network node 401B).

In operation 433, network node 401A may stop the relay service according to the time information to stop the relay service. For example, network node 401A may stop broadcasting system information when the configured time condition is met.

In operation 431, network node 401B may start the relay service according to the time information to start the relay service. For example, network node 401B may start broadcasting system information when the configured condition (e.g., time condition, position condition, or both) is met.

In some embodiments of the present disclosure, in response to the start of the relay service at network node 401B, the UE which was served by network node 401A and was handed over to a neighbor cell may be handed over to network node 401B according to a known handover procedure.

In some embodiments of the present disclosure, neither BS 403 nor network node 401A may perform the handover procedure as described above with respect to operations 421 and 423. For example, since network node 401A and its replacement relay node share the same cell ID (PCI), from the perspective of the UEs served by network node 401A, there is no change in the air interface. Therefore, only a relay replacement may be needed. For example, as described above, the replacement relay node (e.g., network node 401B) may obtain UE context data of at least one UE (e.g., all UEs) served by network node 401A from BS 403 during the replacement.

It should be appreciated by persons skilled in the art that the sequence of the operations in exemplary procedure 400 may be changed and some of the operations in exemplary procedure 400 may be eliminated or modified, without departing from the spirit and scope of the disclosure. For example, although in FIG. 4, operation 415 is shown before operation 417, in some other embodiments of the present disclosure, operation 417 may be performed prior to operation 415.

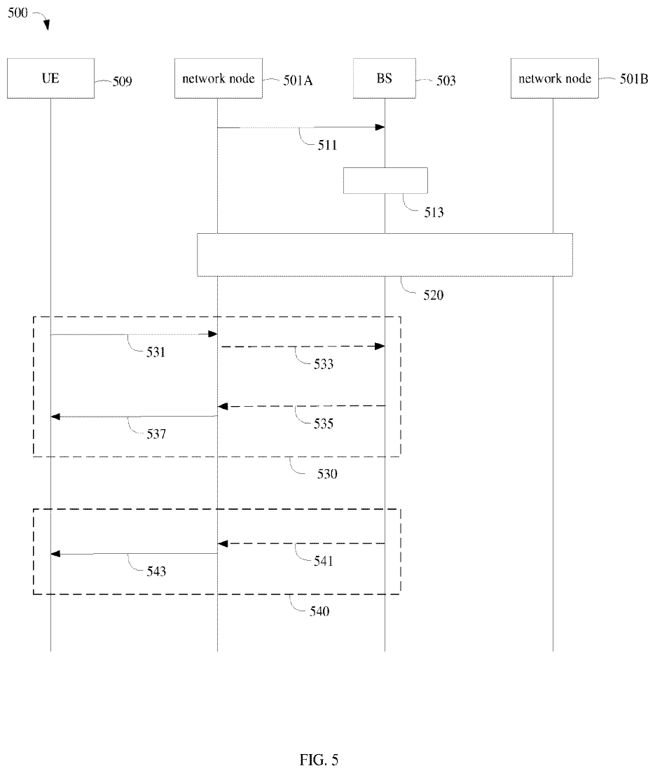

FIG. 5 illustrates an exemplary procedure 500 for wireless communications in accordance with some embodiments of the present disclosure. Details described in all of the foregoing embodiments of the present disclosure are applicable for the embodiments shown in FIG. 5.

Referring to FIG. 5, network node 501A may be connected to BS 503 and may function as a relay node between BS 503 and a UE(s). For example, network node 501A may broadcast system information using its ID (e.g., PCI) within its coverage area so as to provide the relay service. Network node 501A may be a drone or a vehicle. For example, network node 501A may function as UAV 101A or UAV 101B shown in FIG. 1 and BS 503 may function as BS 103 shown in FIG. 1. In the exemplary procedure 500, network node 501A may be an L2 relay or an L3 relay.

In operation 511, network node 501A may transmit assistant information associated with network node 501A to BS 503. In some embodiments of the present disclosure, the assistant information may include one or more of: a request for stopping the relay service at network node 501A, the remaining power of network node 501A, the number of UEs served by network node 501A, and a remaining serving time of network node 501A.

In some examples, similar to the descriptions with respect to FIGS. 2-4, the transmission may be based on one or more conditions including, for example, the remaining power of network node 501A is less than a threshold.

In operation 513, based on the received assistant information, BS 503 may initiate a replacement procedure to replace network node 501A. For example, BS 503 may determine whether to replace network node 501A with a new network node (e.g., network node 501B in FIG. 5) based on the received assistant information. For example, when the power level of the network node 501A is less than a threshold, BS 503 may determine to replace network node 501A with a new network node.

In some other embodiments, similar to the descriptions with respect to FIGS. 2-4, a network entity (e.g., OAM or a UAV platform (e.g., UTM)), which is not shown in FIG. 5, may determine whether to initiate the replacement.

In response to initiating the replacement procedure to replace network node 501A, BS 503 may perform a replacement procedure by, for example, deactivating network node 501A and activating network node 501B as a relay node. For example in procedure 520, BS 503 may transmit an indication (e.g., indication #1-1, indication #2-1, or indication #3-1) to network node 501A to deactivate network node 501A, and may transmit an indication (e.g., indication #1-2, indication #2-2, or indication #3-2) to network node 501B, which is connected to the BS 503, to activate network node 501B as a relay node, as described with respect to FIGS. 2-4.

In some embodiments of the present disclosure, as described with respect to FIGS. 2-4, in the case that network node 501A is an L3 relay, network node 501A may perform a handover procedure to hand over at least one UE (e.g., all UEs) served by network node 501A to a new cell (e.g., a neighbor cell, network node 501B, or another network node).

In some embodiments of the present disclosure, as described with respect to FIGS. 2-4, in the case that network node 501A is an L2 relay, BS 503 may perform a handover procedure to hand over at least one UE (e.g., all UEs) served by network node 501A to a new cell (e.g., a neighbor cell, network node 501B, or another network node).

In some embodiments of the present disclosure, as described with respect to FIGS. 2-4, in response to the activation indication from BS 503, network node 501B may start the relay service. For example, network node 501B may broadcast system information using its ID (e.g., PCI), which may be different from or the same as that of network node 501A. In some embodiments of the present disclosure, the ID (e.g., PCI) of network node 501B may be included in the activation indication.

In some embodiments of the present disclosure, in response to initiating the replacement procedure to replace network node 501A (e.g., after BS 503 or the network entity initiates the replacement procedure, after network node 501A receives the deactivation indication from BS 503, after network node 501A transmits the assistant information to BS 503, during the replacement procedure, or the like), a UE (e.g., an idle UE which is in an RRC_IDLE state as defined in 3GPP specifications) may transmit an radio resource control (RRC) setup request message to network node 501A.

For example, referring to procedure 530 (denoted by the dotted block as an option) of FIG. 5, network node 501A may receive a radio resource control (RRC) setup request message from UE 509 in operation 531. In the case that network node 501A is an L3 relay, in response to receiving the RRC setup request message after, for example, receiving the deactivation indication, network node 501A may transmit an RRC reject message to UE 509 in operation 537.

In the case that network node 501A is an L2 relay, network node 501A may transmit the RRC setup request message to BS 503 in operation 533 (denoted by the dotted arrow as an option). In response to receiving the RRC setup request message after, for example, determining to replace network node 501A, BS 503 may transmit an RRC reject message to network node 501A in operation 535 (denoted by the dotted arrow as an option). Network node 501A may then transmit the RRC reject message to UE 509 in operation 537.

In some embodiments of the present disclosure, the RRC reject message may include at least one of: an ID (e.g., PCI) of network node 501B, and a cause value of cell replacement. In response to receiving the RRC reject message, UE 509 may perform a random access procedure according to, for example, the indicated ID. For example, UE 509 may access network node 501B.

In some embodiments of the present disclosure, in response to initiating the replacement procedure to replace network node 501A (e.g., after BS 503 or the network entity initiates the replacement procedure, after network node 501A receives the deactivation indication from BS 503, after network node 501A transmits the assistant information to BS 503, during the replacement procedure, or the like), an inactive UE (e.g., a UE in an RRC_INACTIVE state as defined in 3GPP specifications) may transmit an RRC resume request message to network node 501A.

For example, referring to procedure 530 (denoted by the dotted block as an option) of FIG. 5, network node 501A may receive an RRC resume request message from UE 509 in operation 531. In the case that network node 501A is an L3 relay, in response to receiving the RRC resume request message after, for example, receiving the deactivation indication, network node 501A may transmit an RRC release message to UE 509 in operation 537.

In the case that network node 501A is an L2 relay, network node 501A may transmit the RRC resume request message to BS 503 in operation 533 (denoted by the dotted arrow as an option). In response to receiving the RRC resume request message after, for example, determining to replace network node 501A, BS 503 may transmit an RRC release message to network node 501A in operation 535 (denoted by the dotted arrow as an option). Network node 501A may then transmit the RRC release message to UE 509 in operation 537.

In some embodiments of the present disclosure, the RRC release message may indicate an ID (e.g., PCI) of network node 501B. For example, the ID of network node 501B may be included in the redirected information in the RRC release message. In response to receiving the RRC release message, UE 509 may perform a random access procedure according to the ID of network node 501B or the redirected information. For example, UE 509 may access network node 501B.

In some embodiments of the present disclosure, in response to initiating the replacement procedure to replace network node 501A (e.g., after BS 503 or the network entity initiates the replacement procedure, after network node 501A receives the deactivation indication from BS 503, after network node 501A transmits the assistant information to BS 503, during the replacement procedure, or the like), a RRC release message may be transmitted to a UE connected to network node 501A.

For example, referring to procedure 540 (denoted by the dotted block as an option) of FIG. 5, in the case that network node 501A is an L3 relay, in response to, for example, receiving the deactivation indication, network node 501A may transmit an RRC release message to a UE (e.g., UE 509) served by network node 501A in operation 543. In the case that network node 501A is an L2 relay, in response to, for example, determining to replace network node 501A, BS 503 may transmit an RRC release message to network node 501A in operation 541 (denoted by the dotted arrow as an option). Network node 501A may then transmit the RRC release message to UE 509 in operation 543.

In some embodiments of the present disclosure, the RRC release message may indicate an ID (e.g., PCI) of network node 501B. For example, the ID of network node 501B may be included in the redirected information in the RRC release message. In response to receiving the RRC release message, UE 509 may perform a random access procedure according to the ID of network node 501B or the redirected information. For example, UE 509 may access network node 501B.

It should be appreciated by persons skilled in the art that the sequence of the operations in exemplary procedure 500 may be changed and some of the operations in exemplary procedure 500 may be eliminated or modified, without departing from the spirit and scope of the disclosure.

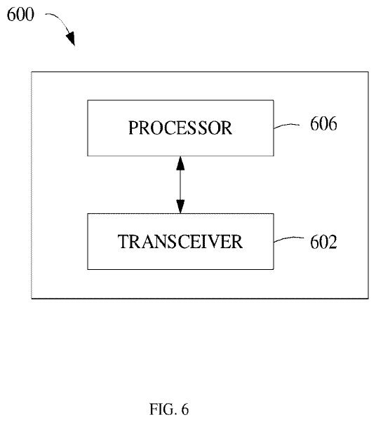

FIG. 6 illustrates a block diagram of an exemplary apparatus 600 according to some embodiments of the present disclosure.

As shown in FIG. 6, the apparatus 600 may include at least one processor 606 and at least one transceiver 602 coupled to the processor 606. The apparatus 600 may be a BS, a network node (e.g., a relay node) or a UE.

Although in this figure, elements such as the at least one transceiver 602 and processor 606 are described in the singular, the plural is contemplated unless a limitation to the singular is explicitly stated. In some embodiments of the present application, the transceiver 602 may be divided into two devices, such as a receiving circuitry and a transmitting circuitry. In some embodiments of the present application, the apparatus 600 may further include an input device, a memory, and/or other components.

In some embodiments of the present application, the apparatus 600 may be a BS. The transceiver 602 may be configured to receive assistant information from a first network node, wherein the first network node functions as a relay node between the BS and a UE. The processor 606 may be configured to determine to replace the first network node with a second network node based on the assistant information. The transceiver may be further configured to: transmit, to the first network node, a first indication to deactivate the first network node; and transmit, to the second network node, a second indication to activate the second network node as a relay node, wherein the second network node accesses the BS.

In some embodiments of the present disclosure, the transceiver 602 and the processor 606 may interact with each other so as to perform the operations with respect to the BSs described in FIGS. 1-5.

In some embodiments of the present application, the apparatus 600 may be a network node. The transceiver 602 may be configured to transmit, to a BS, assistant information, wherein the network node functions as a relay node between the BS and a UE; and receive, from the BS, an indication to deactivate the network node in response to transmitting the assistant information.

In some embodiments of the present application, the apparatus 600 may be a network node. The transceiver 602 may be configured to receive, from a BS, an indication to activate the network node as a relay node. The processor 606 may be configured to start a relay service in response to receiving the indication.

In some embodiments of the present disclosure, the transceiver 602 and the processor 606 may interact with each other so as to perform the operations with respect to the network nodes described in FIGS. 1-5.

In some embodiments of the present application, the apparatus 600 may further include at least one non-transitory computer-readable medium. In some embodiments of the present disclosure, the non-transitory computer-readable medium may have stored thereon computer-executable instructions to cause the processor 606 to implement the method with respect to the BSs as described above. For example, the computer-executable instructions, when executed, cause the processor 606 interacting with transceiver 602 to perform the operations with respect to the BSs described in FIGS. 1-5.

In some embodiments of the present application, the apparatus 600 may further include at least one non-transitory computer-readable medium. In some embodiments of the present disclosure, the non-transitory computer-readable medium may have stored thereon computer-executable instructions to cause the processor 606 to implement the method with respect to the network nodes as described above. For example, the computer-executable instructions, when executed, cause the processor 606 interacting with transceiver 602 to perform the operations with respect to the network nodes described in FIGS. 1-5.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing elements of the independent claims. Accordingly, embodiments of the disclosure as set forth herein are intended to be illustrative, not limiting. Various changes may be made without departing from the spirit and scope of the disclosure.

In this document, the terms “includes,” “including.” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A method performed by a base station (BS), comprising:
receiving assistant information associated with a first network node, which functions as a relay node between the BS and a user equipment (UE); and
in response to initiating a replacement procedure to replace the first network node based on the received assistant information, deactivating the first network node and activating a second network node as the relay node.

2. The method of claim 1, wherein the first network node and the second network node are each at least one of a drone or a vehicle.

3. The method of claim 1, wherein the assistant information comprises one or more of:
a request to deactivate a function as relay between the BS and the UE at the first network node;
a remaining power of the first network node;
a remaining serving time of the first network node; or
an acknowledgement that no UEs are being served by the first network node.

4. The method of claim 1, wherein the deactivating the first network node comprises transmitting, to the first network node, an indication of at least one of:
an identifier (ID) of the second network node;
a condition for deactivating a function as a relay between the BS and the UE at the first network node; and
time information to deactivate the function of the relay between the BS and the UE at the first network node.

5. The method of claim 1, wherein the activating the second network node comprises transmitting, to the second network node, an identifier (ID) of the second network node.

6-14. (canceled)

15. A base station (BS) for wireless communication, comprising:
at least one memory; and
at least one processor coupled with the at least one memory and configured to cause the BS to:
receive assistant information associated with a first network node that functions as a relay node between the BS and a user equipment (UE); and
deactivate the first network node and activate a second network node as the relay node in response to a replacement procedure initiated to replace the first network node based on the assistant information.

16. The BS of claim 15, wherein the first network node and the second network node are each at least one of a drone or a vehicle.

17. The BS of claim 15, wherein the assistant information comprises at least one of:
a request to deactivate a function as relay between the BS and the UE at the first network node;
a remaining power of the first network node;
a remaining serving time of the first network node; or
an acknowledgement that no UEs are being served by the first network node.

18. The BS of claim 15, wherein, to deactivate the first network node, the at least one processor is configured to cause the BS to transmit, to the first network node, an indication of at least one of:
an identifier (ID) of the second network node;
a condition for deactivating a function as a relay between the BS and the UE at the first network node; or
time information to deactivate the function of the relay between the BS and the UE at the first network node, the time information indicating an absolute time value or a timer value.

19. The BS of claim 18, wherein the condition indicates at least one of:
additional time information for handing over a predetermined number of UEs served by the first network node to the second network node;
a plurality of UEs to be handed over by the first network node to the second network node; or
a remaining power of the first network node.

20. The BS of claim 15, wherein, to activate the second network node, the at least one processor is configured to cause the BS to transmit, to the second network node, an identifier (ID) of the second network node.

21. The BS of claim 15, wherein the at least one processor is configured to cause the BS to transmit a UE context of an additional UE to the second network node if the additional UE served by the first network node is handed over to a different network node other than the second network node.

22. The BS of claim 15, wherein an identifier (ID) of the second network node is the ID of the first network node.

23. The BS of claim 15, wherein, to activate the second network node, the at least one processor is configured to cause the BS to transmit, to the second network node, a second indication of at least one of:
time information to activate a function of a relay at the second network node, the time information indicating an absolute time value or a timer value; or
a position of the second network node to activate the function of the relay at the second network node.

24. The BS of claim 15, wherein the at least one processor is configured to cause the BS to transmit a UE context of the UE served by the first network node to the second network node.

25. The BS of claim 15, wherein the at least one processor is configured to cause the BS to:
receive, from an idle UE via the first network node, a radio resource control (RRC) setup request message in response to the replacement procedure being initiated to replace the first network node; and
transmit, to the idle UE via the first network node, an RRC reject message in response to the RRC setup request message that comprises least one of an identifier (ID) of the second network node, or a cause value of cell replacement.

26. The BS of claim 15, wherein, in response to the replacement procedure being initiated to replace the first network node, the at least one processor is configured to cause the BS to transmit a radio resource control (RRC) release message to the UE connected to the BS via the first network node, the RRC release message comprising an identifier (ID) of the second network node.

27. The BS of claim 15, wherein the at least one processor is configured to cause the BS to:
receive, from an inactive UE via the first network node, a radio resource control (RRC) resume request message after the replacement procedure is initiated to replace the first network node; and
transmit, to the inactive UE via the first network node, an RRC release message that comprises an identifier (ID) of the second network node.

28. A network node for wireless communication, comprising:
at least one memory; and
at least one processor coupled with the at least one memory and configured to cause the network node to:
transmit, to a base station (BS), assistant information associated with the network node that functions as a relay node between the BS and a user equipment (UE);
receive, from the BS, a deactivation indication to deactivate the network node as the relay node; and
deactivate the network node in response to the deactivation indication.

29. A user equipment (UE) for wireless communication, comprising:
at least one memory; and
at least one processor coupled with the at least one memory and configured to cause the UE to:
transmit a radio resource control (RRC) setup request message to a first network node that transmits the RRC setup request message to a base station (BS);
receive a RRC reject message from the first network node that receives the RRC reject message from the BS, the RRC reject message indicating an identifier of a second network node; and
perform a random access procedure according to the identifier to initiate accessing the second network node.
